(19) United States
(12) Patent Application Publication
(10) Pub. No.: US 2007/0283003 A1
(43) Pub. Date: Dec. 6, 2007

(54) System and method for provisioning a computer system

(76) Inventors: Paul J. Broyles, Houston, TX (US); Mark A. Piwonka, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/445,077

(22) Filed: May 31, 2006

(51) Int. Cl. G06F 15/173

(52) U.S. Cl. 709/224

(57) ABSTRACT

There is provided a system and a method for provisioning a computer system. More specifically, in accordance with one embodiment, there is provided a computer system configured to generate provisioning information for the computer system, wherein the provisioning information includes a product identifier and a passphrase, and upload the provisioning information into a remote access system for the computer system.

### BACKGROUND

This section is intended to introduce the reader to various aspects of art, which may be related to various aspects of the present invention that are described and claimed below. This discussion is believed to be helpful in providing the reader with background information to facilitate a better understanding of the various aspects of the present invention. Accordingly, it should be understood that these statements are to be read in this light, and not as admissions of prior art.

Computers and computer-related technologies have become an integral part of the lives of more and more people. Many people now rely on computers for a variety of tasks, such as shopping, investing, and/or banking. However, like most other types of machines, computers may benefit from occasional or periodic maintenance, upgrades, or repairs. Years ago, such maintenance, upgrades, or repairs often involved a qualified technician or other person physically interacting with the computer (e.g., sitting in front of the computer's monitor and keyboard). In modern times, however, many types of remote access systems have been developed to enable maintenance, upgrades, or repairs to be performed remotely over a computer network. One of these tools is the Active Management Technology (“AMT”) system created by Intel. AMT enables a remote console (such as another computer) to access a computer system over a network to perform some types of maintenance, upgrades, or repairs.

Although this type of remote control may enable more efficient maintenance, upgrades, or repairs, this type of remote control also raises several security concerns. For example, under the control of a malicious person, AMT could be used to erase sensitive data, shut down vital computer systems, or perform other damaging activities. For this reason, AMT includes safeguards to tightly regulate access to controllable computer systems. For example, AMT is configured to permit a remote console to control the computer system only if provisioning information stored on the remote console matches provisioning information on the computer system. Typically, this provisioning information includes a password or encryption key of 40 characters or more. In this way, AMT endeavors to ensure that only authorized remote consoles are granted access and/or control of controllable computer systems.

### BRIEF DESCRIPTION OF THE DRAWINGS

FIG. 1 is a block diagram of an exemplary computer system in accordance with one embodiment;

FIG. 2 is a flow chart illustrating an exemplary technique for provisioning a computer system in accordance with one embodiment;

FIG. 3 is a flow chart illustrating an exemplary technique for uploading provisioning information into a remote console in accordance with one embodiment; and

FIG. 4 is a block diagram of an exemplary computer network in accordance with one embodiment.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, Active Management Technology (“AMT”) and other suitable remote access systems typically condition access to controllable computer systems by a remote console with provisioning information, such as passwords and/or keys. Furthermore, to improve security, many remote access systems employ provisioning information including 40 or more characters (e.g., AMT employs a 40 character pre-shared key and a 8 character administrator password). It may be difficult, however, for a user to manually create a random 40 character key and/or manually enter this key into both the computer system to be controlled and the remote console (entry of the provisioning information is referred to as “provisioning” a system). As such, one or more of the embodiments described herein may be directed towards a system or method for provisioning a computer system and/or a remote console. Specifically, in one embodiment, there is provided a computer system configured to generate provisioning information for itself and to store the provisioning information on a storage medium suitable for accessing by a remote console.

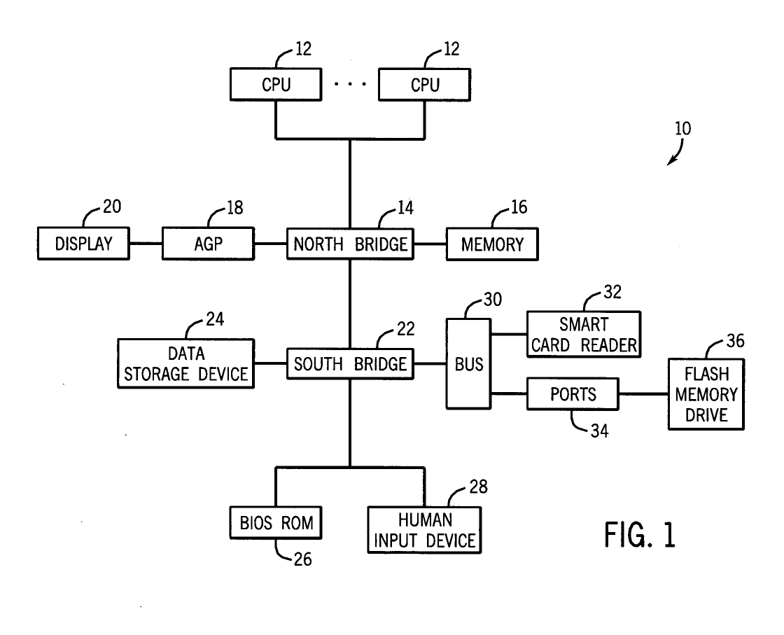

Turning now to FIG. 1, a block diagram of an exemplary computer system configured to generate provisioning information for itself in accordance with one embodiment is illustrated and generally designated by a reference numeral 10. The computer system 10 may include one or more processors or central processing units (“CPUs”) 12. While the CPU 12 will be referred to primarily in the singular, it will be understood that a computer system 10 with any number of physical or logical CPUs 12 may be implemented. Examples of suitable CPUs 12 include the Intel Pentium 4 Processor and the AMD Athlon Processor.

The CPU 12 may be communicatively coupled to a north bridge 14, such as an Intel 82451NX Memory and I/O Bridge Controller (“MIOC”). The north bridge 14 may be an interface (either directly or indirectly) between the CPU 12 and the rest of the components of the system 10. The north bridge 14 may contain a memory controller for accessing a main memory 16 (e.g., dynamic random access memory (“DRAM”)). The north bridge 14 may also be communicatively coupled to an accelerated graphics port (“AGP”) 18. The AGP 18 can transmit video data through an AGP video card (not shown) to a video display 20, which can display the video data for a user.

The north bridge 14 may also be communicatively coupled to a south bridge 22. The south bridge 22 is an integrated multifunctional component, such as the Intel 82371 (a.k.a. PIIX4). The south bridge 22 may include a controller which may enable the south bridge 22 to communicate and/or control a data storage device 24. The data storage device 24 may include any one of a variety of suitable data storage devices. For example, in one embodiment, the data storage device 24 is an IDE or ATA hard drive. In alternate embodiments, the data storage device 24 may be a small computer system interface (“SCSI”) drive or a fibre channel drive. In still other embodiments, the date storage device may be a solid state data storage device or optical data storage device.

The south bridge may also be coupled to a basic input/output system (“BIOS”) read-only memory (“ROM”) 26. The BIOS ROM 26 may be configured to store code or instructions for setting up or configuring the operation of the computer system 10. For example, in one embodiment, the code or instructions stored in the BIOS ROM 26 may, when executed, produce a setup or configuration interface that can be accessed by pressing the F10 key on a keyboard (hereafter referred to as “the F10 setup”). As described further below, the BIOS ROM 26 may also be configured to store code or instructions for generating provisioning information for the computer system 10 and/or for storing the provisioning information on a storage medium.

The south bridge 22 may also be coupled to a variety of human input devices 28, such as the keyboard and/or a mouse. Further, while not illustrated in FIG. 1, the south bridge 22 may also include an enhanced direct memory access (“DMA”) controller; an interrupt controller; a timer; a universal serial bus (“USB”) host controller for providing a universal serial bus (not shown); and an industry standard architecture (“ISA”) bus controller for providing an ISA bus (not shown).

The south bridge 22 may also be communicatively coupled to an expansion bus 30. The expansion bus 30 may permit the addition of expansion cards into the computer system 10. The expansion bus 30 may employ any one of a number of suitable expansion bus technologies, including Peripheral Component Interconnect (“PCI”), PCI-X, PCI express, and the like. As such, it will be appreciated that PCI, PCI-X, and PCI express are merely exemplary, and in alternate embodiments, other suitable expansion bus technologies may be employed as well.

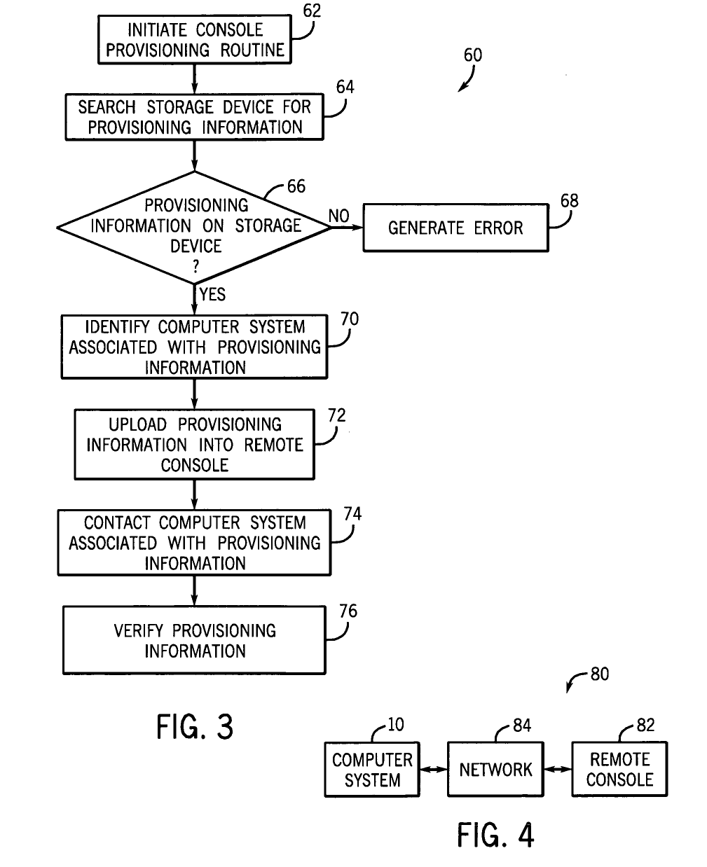

Returning to FIG. 1, the expansion bus 30 may be communicatively coupled to a smart card reader 32. In one embodiment, the smart card reader 32 is configured to be coupled to a smart card that stores provisioning information, such as a key or password. It will be appreciated that a smart card may be a card-shaped medium that contains an embedded microprocessor and/or semiconductor memory to enable the smart card to store data, such as the provisioning information. In one embodiment, the smart card may store provisioning information including a 40 character pre-shared key (“PSK”) comprising an 8 character product ID (“PID”) and a 32 character passphrase (“PPS”) as well as an 8 character administrator password. Further, in one embodiment the PSK and/or administrator password may be generated randomly by the CPU 12. As described in greater detail below, the PSK and/or administrator password may also be able to be downloaded from the smart card by a console server (see FIGS. 3 and 4).

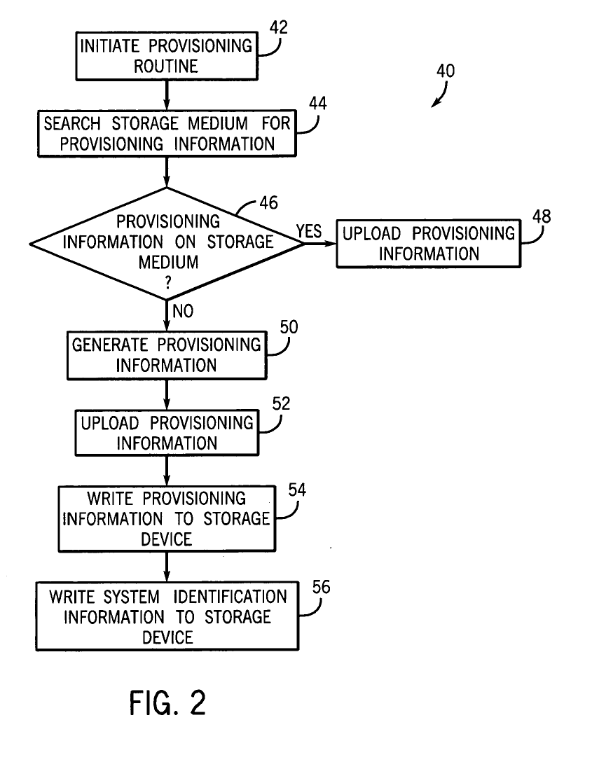

The expansion bus 30 may also be communicatively coupled to one or more ports 34. The ports 34 may include a Universal Serial Bus (“USB”) port, an IEEE-1394 port, or another suitable type of port. In addition, the ports 34 may also include or be communicatively coupled to a wireless transceiver, such as a Bluetooth transceiver or I.E.E.E. 802.11 transceiver, capable of be being communicatively coupled wirelessly to the external storage device. The ports 34 may be communicatively coupled to a storage device, such as a flash memory device (not shown) to store provisioning information generated by the computer system 10. As described further below with regard to FIGS. 2-4, the computer system 10 may be configured to store provisioning information on a USB flash memory device 36 that can subsequently be employed to upload the provisioning information to a remote console. For example, the computer system may store the PSK and/or administrator password (as described above) on the USB flash memory device 36. It will be appreciated, however, that the USB flash memory device 36 is merely one example of a suitable storage device.

Further, it should be noted that the embodiment of the computer system 10 illustrated in FIG. 1 is merely one exemplary embodiment of the computer system 10. For example, in alternate embodiments, the computer system 10 may include thin client systems, distributed computer systems, servers, personal digital assistants, and/or wireless telephones. As such, in alternate embodiments, the above described elements may be reconfigured and/or certain elements omitted from the computer system 10. For example, in one alternate embodiment, the north bridge 14 and the south bridge 22 may be replaced by a single integrated chipset. In still other embodiments, the memory 16 and/or the ports 34 may be coupled directly to the CPU 12.

As described above, the computer system 10 may be configured to generate provisioning information for itself and to store this provisioning information on a storage medium, such as a smart card, the USB flash memory device 36, a Bluetooth flash memory device, and the like. Accordingly, FIG. 2 is a flow chart illustrating an exemplary technique 40 for provisioning a computer system in accordance with one embodiment. In one embodiment, the computer system 10 may execute the technique 40 to provisioning itself. As such, in this embodiment, code adapted to execute the technique 40 may be stored on a tangible machine readable medium within the computer system 10, such as the BIOS ROM 26.

As indicated by block 42 of FIG. 2, the technique 40 may begin with the computer system 10 initiating a provisioning routine. In one embodiment, the provisioning routine may be initiated in response to a user selection or input during the F10 setup. After the provisioning routine has been initiated, the computer system 10 may be configured to search a storage medium for provisioning information for the computer system 10, as indicated by block 44. In one embodiment, searching the storage medium 36 may include searching the data storage device 24, smart cards coupled to the smart card reader 32, storage devices coupled to the ports 34, and/or other suitable storage media coupled to the computer system 10. For example, in one embodiment, searching the storage medium may include searching the USB flash memory device 36.

If the provisioning information is located on the storage medium (block 46), the computer system 10 may be configured to upload the stored provisioning information in the remote access system of the computer system 10, as indicated by block 48. In one embodiment, uploading the provisioning information may include uploading a PSK and/or administrator password into the AMT system. If, on the other hand, provisioning information is not found on the storage medium, the computer system 10 may be configured to generate its own provisioning information, as indicated by block 50. In one embodiment, generating provisioning information may include randomly generating a PSK and/or administrator password as described above. In alternate embodiments, however, generating provisioning information may include generating any suitable form of passphrase, password, and/or key.

After the computer system 10 has generated the provisioning information, it may upload the provisioning information in the remote access system, as indicated by block 52. In one embodiment, uploading the provisioning information may include uploading the PSK and/or administrator password into the AMT system. Alternatively, the provisioning information may be stored in the data storage device 24 or other storage media for use by the AMT system at a later time.

In addition, the computer system 10 may also be configured to write the provisioning information to a storage device capable of being accessed by a remote console, as indicated by block 54. In various embodiments, this storage device may include a smart card, a memory card or stick, a solid state or semiconductor memory device, such as the USB flash memory device 36, a personal digital assistant, such as an iPAQ, a diskette, an optical medium, a wireless device, a Bluetooth-enabled device, or any other suitable form of external storage media that can be communicatively coupled to the computer system 10. For example, the storage device may be a flash memory device including a rigid body (e.g., a plastic body) affixed to a tangible machine readable medium, such as a semiconductor memory, which may be configured to store the PSK and/or administrator password.

As described further below with regard to FIGS. 3 and 4, the storage device (e.g. the USB flash memory device 36) may be decoupled from the computer system 10 and coupled to a remote console 82 (see FIG. 4). In other embodiments, however, the provisioning information may be written to any other suitable type of storage device. For example, the provisioning information may be written to a network storage device, which is accessible by remote console over a network. It will be appreciated, however, that the above-recited examples are merely exemplary and, as such, not intended to be exclusive.

In addition to writing the provisioning information to the storage device, the computer system 10 may also be configured to write identification information associated with the provisioning information to the storage device, as indicated by block 56. For example, in one embodiment, the computer system 10 may be configured to write its serial number (“S/N”) and/or universally unique identifier (“UUID”) to the storage device. It will also be appreciated that writing the identification information to the storage device may enable the storage device to be used to store provisioning information for multiple computer systems.

As described above, the computer system 10 may be configured to write provisioning information and system identification information to a storage device, such as a USB flash memory device 36. As described below, this provisioning information may be subsequently accessed by a remote console that is being configured to access and/or control the computer system 10. Accordingly, FIG. 3 is a flow chart illustrating an exemplary technique 60 for uploading provisioning information into a remote console in accordance with one embodiment. For ease of explanation, the technique 60 will be described in conjunction with exemplary computer network 80, a block diagram of which is illustrated in FIG. 4 in accordance with one embodiment. In one embodiment, the technique 60 may be executed by the remote console 82 that is coupled to the computer system 10 over a network 84 (see FIG. 4).

As indicated by block 62 of FIG. 3, the technique 60 may begin by initiating a console provisioning routine. In one embodiment, initiating the console provisioning routine may include executing a software program or package. For example, the console provisioning routine may be part of a Windows or UNIX-based AMT program for remotely managing the computer system 10.

Next, the remote console 82 may be configured to search the storage device (see FIG. 2) for provisioning information, as indicated by block 64. For example, the remote console 82 may be configured to search the USB flash memory device 36. If provisioning information is not found on the storage device (block 66), the remote console 82 may be configured to generate an error, as indicated by block 68. If, however, the remote console 82 is able to locate provisioning information on the storage device, the remote console 82 may identify the computer system associated with the provisioning information, as indicated by block 70. For example, in one embodiment, the remote console 82 may be configured to access the identification information written to the storage device by the computer system 10 (see block 56 of FIG. 2). In another embodiment, the remote console 82 may be configured to query a user or other system as to the identity of the computer system associated with the provisioning information located on the storage device.

After identifying the computer system associated with the provisioning information, the remote console 82 may upload the provisioning information from the storage device, as indicated by block 72. In one embodiment, uploading the provisioning information may include storing the provisioning information in a location accessible by the software program or package configured to remotely access (e.g., maintain, upgrade, or repair) the computer system 10. For example, the PSK and/or administrator password may be uploaded from the USB flash memory device 36 into an AMT software program loaded on the remote console 82.

In addition, once the provisioning information has been uploaded, the remote console 82 may also be configured to verify the provisioning information. In one embodiment, this verification may include contacting the computer system associated with the provisioning information (e.g., the computer system 10) over the network 84, as indicated by block 74. After contacting the computer system associated with the provisioning information, the remote console 82 may be configured to verify the provisioning information is correct, as indicated in block 76. In one embodiment, this verification may include attempting to access the computer system 10 over the network 84 and/or attempting to transmit a command to the computer system 10. If the remote console 82 is able to access and/or command the computer system 10, the remote console 82 may determine that the provisioning information uploaded into the remote console 82 matches the provisioning information stored within the computer system 10, and as such, that the uploaded provisioning information was correct.

While the invention described above may be susceptible to various modifications and alternative forms, specific embodiments have been shown by way of example in the drawings and have been described in detail herein. It should be understood, however, that the invention is not intended to be limited to the particular embodiments disclosed.

What is claimed:

1. A computer system configured to:
generate provisioning information for the computer system, wherein the provisioning information includes a product identifier and a passphrase; and
upload the provisioning information into a remote access system of the computer system.

2. The computer system, as set forth in claim 1, wherein the computer system is configured to write the provisioning information to a storage device.

3. The computer system, as set forth in claim 2, wherein the computer system is configured to write the provisioning information to a flash memory device.

4. The computer system, as set forth in claim 2, wherein the computer system is configured to write system identification information associated with the computer system to the storage device.

5. The computer system, as set forth in claim 4, wherein the computer system is configured to write a universally unique identifier to the storage device.

6. The computer system, as set forth in claim 1, wherein the computer system is configured to search a storage medium for the provisioning information prior to generating the provisioning information.

7. The computer system, as set forth in claim 1, wherein the computer system configured to generate provisioning information is configured to generate an eight character product identifier and a thirty-two character passphrase.

8. The computer system, as set forth in claim 7, wherein the computer system is configured to generate an eight character administrator password.

9. A tangible machine readable medium comprising:
code adapted to generate provisioning information for a computer system, wherein the provisioning information comprises a product identifier and a passphrase; and
code adapted to upload the provisioning information into a remote access system for the computer system.

10. The tangible machine readable medium, as set forth in claim 9, wherein the tangible medium comprises a BIOS read only memory.

11. The tangible machine readable medium, as set forth in claim 9, wherein the tangible medium comprises code adapted to write the provisioning information to a storage device of the computer system.

12. The tangible machine readable medium, as set forth in claim 9, wherein the tangible medium comprises code adapted to write the provisioning information to the flash memory device of the computer system.

13. The tangible machine readable medium, as set forth in claim 9, wherein the tangible medium comprises code adapted to upload the provisioning information into an active management technology system for the computer system.

14. The tangible machine readable medium, as set forth in claim 9, wherein the code adapted to generate the passphrase comprises code adapted to randomly generate a thirty-two character passphrase.

15. The tangible machine readable medium, as set forth in claim 9, wherein the code adapted to generate the product identifier comprises code adapted to randomly generate an eight character product identifier.

16. A method comprising:
locating provisioning information on a storage device, wherein the provisioning information is associated with a computer system and wherein the provisioning information was generated by the computer system;
identifying the computer system that generated the provisioning information based on an identifier associated with the provisioning information, wherein the identifier is stored on the storage device;
uploading the provisioning information into a remote access system configured to access the computer system over a network; and
accessing the computer system over the network using the provisioning information.

17. The method, as set forth in claim 16, wherein uploading the provisioning information comprises uploading a product identifier and a passphrase into an active management technology system.

18. The method, as set forth in claim 17, wherein uploading the product identifier key comprises uploading an eight character product identifier into a remote console.

19. The method, as set forth in claim 17, wherein uploading the passphrase comprises uploading a thirty-two character passphrase.

20. The method, as set forth in claim 17, wherein identifying the computer system that generated the provisioning information based on an identifier comprises identifying the computer system based on a universally unique identifier.
